(19) United States
(12) Patent Application Publication
(10) Pub. No.: US 2006/0174602 A1
(43) Pub. Date: Aug. 10, 2006

(54) Replaceable reel blade system

(75) Inventors: Jonathan Dohme Fairchild Mahan, Charlotte, NC (US); Vivek Moinikunta, Charlotte, NC (US); Lynn Westbrook, Lake Wylie, SC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/053,049

(22) Filed: Feb. 8, 2005

(51) Int. Cl. A01D 34/53

(52) U.S. Cl. 56/249

(57) ABSTRACT

A reel mower assembly having a frame and a reel rotatably mounted to the frame. The reel includes a plurality of cross members connected with a reel shaft. A drive is operable to rotate the reel about a reel axis. A blade member is removably coupled to one of the plurality of cross members to prevent movement of the blade member with respect to the cross member, yet permit easily replacement thereof.

### FIELD OF THE INVENTION

The present invention relates to a reel mower, and more particularly, to a replaceable reel blade system for a reel mower.

### BACKGROUND OF THE INVENTION

Reel mowers use a scissoring action, rather than a tearing action, to shear grass and like foliage. Such reel mowers typically provide a high quality cut, but require more maintenance than rotary mowers. Golf course superintendents prefer such mowers where appearance and healthy grass are important, such as on golf greens.

In a typical reel mower assembly, an attachment member, commonly called a bedbar or backer, attaches to the apparatus in rigid relationship to the reel, and a replaceable bedknife attaches to the bedbar. The bedknife is maintained parallel to the reel axis and in close proximity to the reel knives so that the reel and the bedknives achieve a quality sheering action. Typically, an adjustment mechanism allows movement of the bedbar relative to the reel so that the bedknife can be moved into proper relationship with the rotating reel.

More specifically, conventional reel blade systems include a reel that is supported for rotation about a fixed axis. The reel is operably coupled to a power device, such as an electric motor, internal combustion motor, or manual gear system, which serves to rotatably drive the reel relative to a fixed bedknife. The bedknife is typically attached to a bedbar with a plurality of screws placed through holes in the bedknife and into engagement with threaded holes formed in the bedbar. A reel mower unit used in a typical golf course application may use multiple reel mower assemblies.

Conventional reels often present many challenges for manufacture because of their complex assembly of multiple components that require extensive machining and/or welding. For instance, conventional reel assemblies require a shaft, a plurality of spiders welded to and extending from the shaft within a predetermined tolerance, and a plurality of blades fixedly coupled to the plurality of spiders. The shaft, spiders, and blades are further machined to facilitate coupling with additional mower components and each other. As a result of the need to weld various portions of the reel assembly, the maximum blade material hardness is limited. Furthermore, it should be appreciated that as a result of such complex manufacturing steps, the complexity and resultant costs are increased.

During operation, reel assemblies are often subjected to damaging debris, such as stones and the like, debris sometimes jams between the fixed bedknife and the rotating reel. Consequently, damage to one or more portions of the reel mower assembly may result. Reels may also sustain damage when contacting a substantially buried obstruction. Damage to the reel can be quite costly and problematic, given the close tolerances required for proper operation. Furthermore, a reel tends to wear the more often it is used, thereby requiring skilled and costly adjustment of the bedknife relative to the reel.

### SUMMARY OF THE INVENTION

The present invention relates to a reel mower assembly comprising a frame and a reel rotatably mounted to the frame. The reel includes a plurality of cross members connected with a reel shaft. A drive is operable to rotate the reel about a reel axis. A blade member is removably coupled to one of the plurality of cross members to prevent movement of the blade member with respect to the cross member, yet permit easily replacement thereof. The blade member may be removably coupled to one of the plurality of cross members according to any one of a number of methods disclosed herein, such as through a magnetic interface, an adhesive interface, an interference fit, a tongue and groove fit, or conventional fasteners.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective view of a walk-behind reel mower incorporating the replaceable reel blade system of the present invention;

FIG. 2 is a perspective view of the replaceable reel blade system of one embodiment of the present invention;

FIG. 3 is a side view of the replaceable reel blade system of FIG. 2;

FIG. 4 is a perspective view of the replaceable reel blade system of another embodiment of the present invention;

FIG. 5 is a perspective view of the replaceable reel blade system of yet another embodiment of the present invention; and

FIG. 6 is a side view of the replaceable reel blade system illustrating a tongue and groove engagement system.

### DETAILED DESCRIPTION OF THE PREFERRED EMBODIMENTS

The following description of the preferred embodiments is merely exemplary in nature and is in no way intended to limit the invention, its application, or uses.

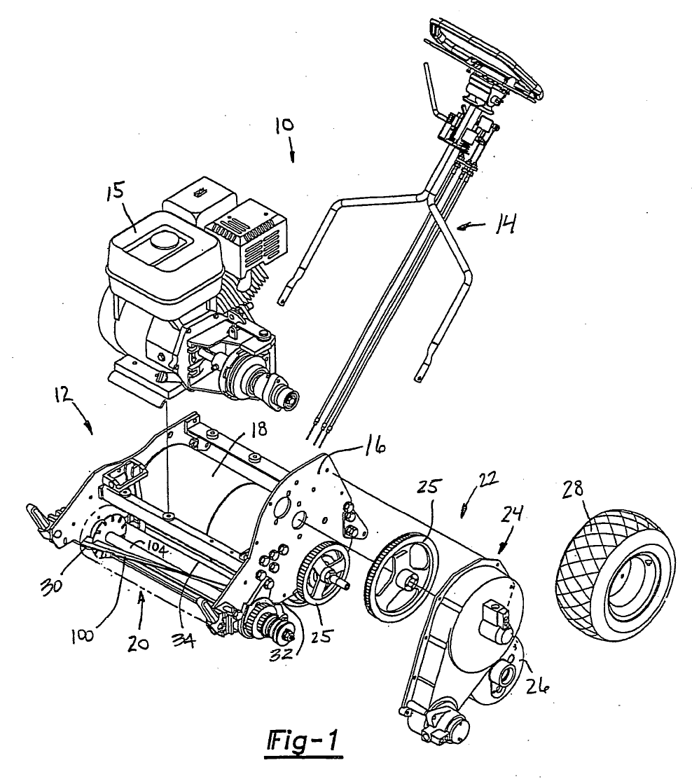

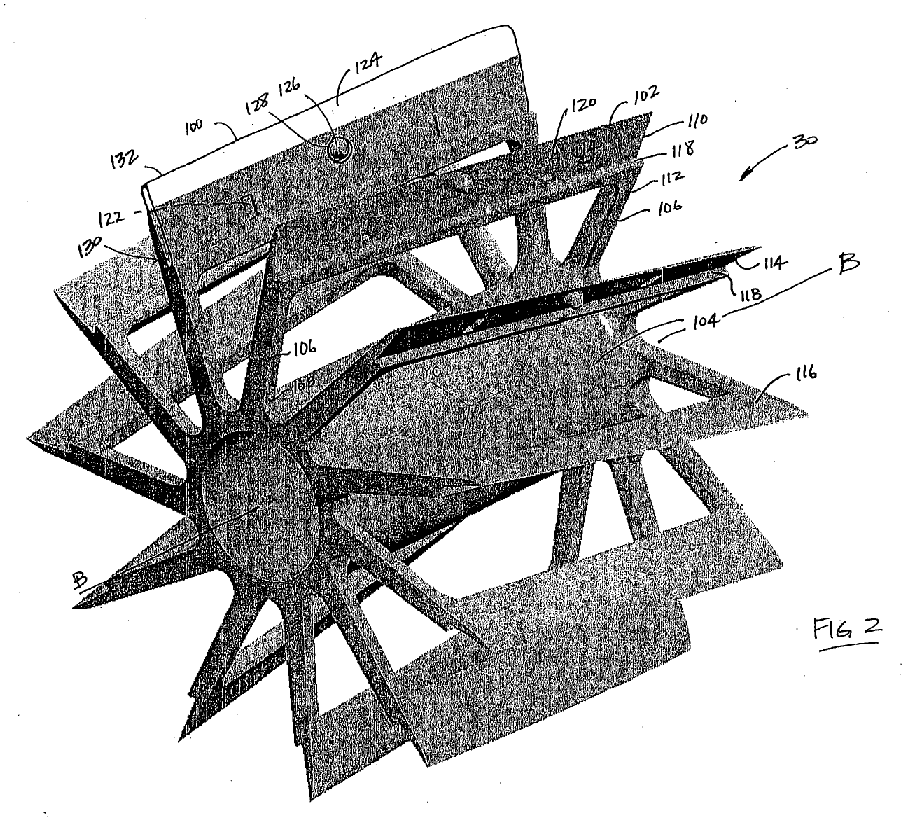

FIG. 1 shows the basic components of a mower 10 constructed in accordance with the present invention. Mower 10 is shown as a walk-behind mower; however, mower 10 can be any variety of reel-type greensmowers, including single, multiple walk-behind, stand-behind, and riding reel-type mowing devices. Mower 10 includes cutting unit 12, which comprises a power source or engine 15 coupled to a frame 16, and a handle 14 coupled to frame 16. A traction roller 18 is rotatably coupled to frame 16 and drivingly connected to an engine 15. Cutting unit 12 further includes a reel mower assembly 20, described in detail with respect to FIGS. 2-5. A transmission 22 includes within a housing 24 a plurality of sprockets 25 selectively transferring rotational output torque of engine 15 to traction roller 18. Transmission 22 includes a clutch 26 positioned intermediate engine 15 and transmission 22. Clutch 26 operates in an engaged and disengaged mode for selectively transferring power from engine 15 to traction roller 18. Wheels 28 are coupled to traction roller 18 and are also selectively driven by engine 15 to provide motive force for translating walk-behind greensmower 10, typically during a transportation mode of operation.

Reel mower assembly 20 includes a mower reel 30 mounted to frame 16 to enable relative rotational movement. Reel mower assembly 20 is commonly found on various types of mowers, including riding mowers and walk-behind mowers. A drive rotates reel 30 about a reel axis A. A bedbar 32 attaches to frame 16 and bedknife 34 attaches to bedbar 32. Typically, reel 30 further includes an adjustment mechanism to vary the position of bedbar 32 with respect to reel 30 in order to provide the proper cutting relationship between bedknife 34 and reel 30.

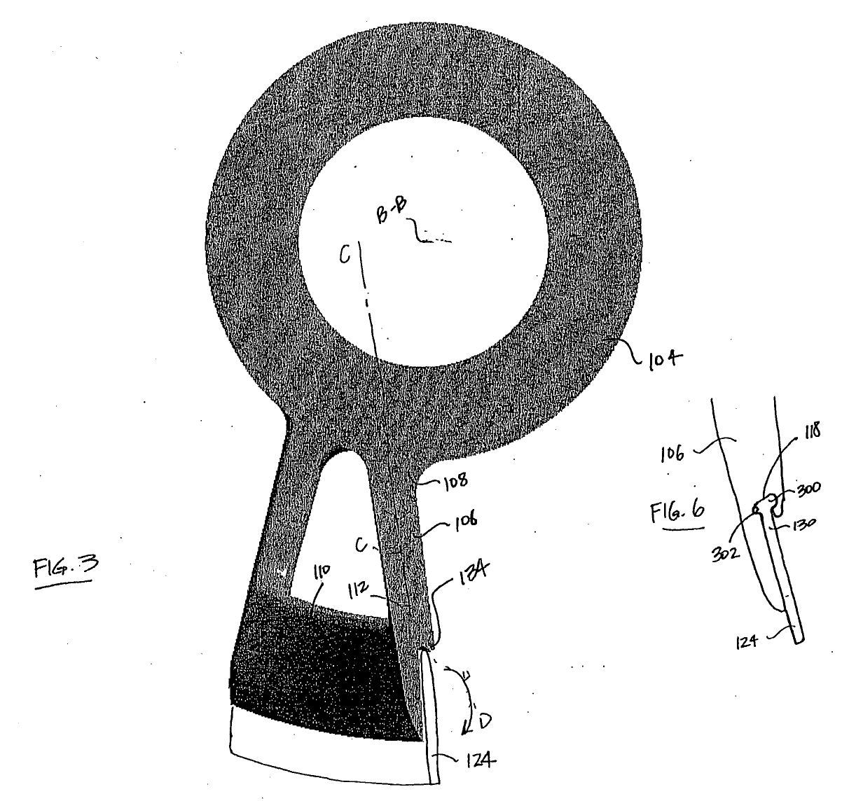

With reference to FIGS. 2-5, it can be seen that each of the embodiments of reel 30 has certain features that are generally common to each other. Specifically, with reference to FIGS. 2 and 3, reel 30 includes a circular array of cutting blades 100 arranged generally in a helix with the axis of rotation of reel 30 being coaxial with the axis for each blade helix. In order to properly position each cutting blade 100 at this predetermined helical position, a plurality of helically-arranged blade supports or blade backers 102 are provided for mounting cutting blades 100 thereto. The particular mounting method of cutting blade 100 to blade supports 102 will be discussed in detail below. Blade supports 102 are mounted to or formed integrally with a reel shaft 104. However, it should be understood that reel shaft 104 may have additional shafts (not shown) fixed within ends thereof for mounting with frame 16. These additional shafts may be threaded or press-fit into connection with reel shaft 104.

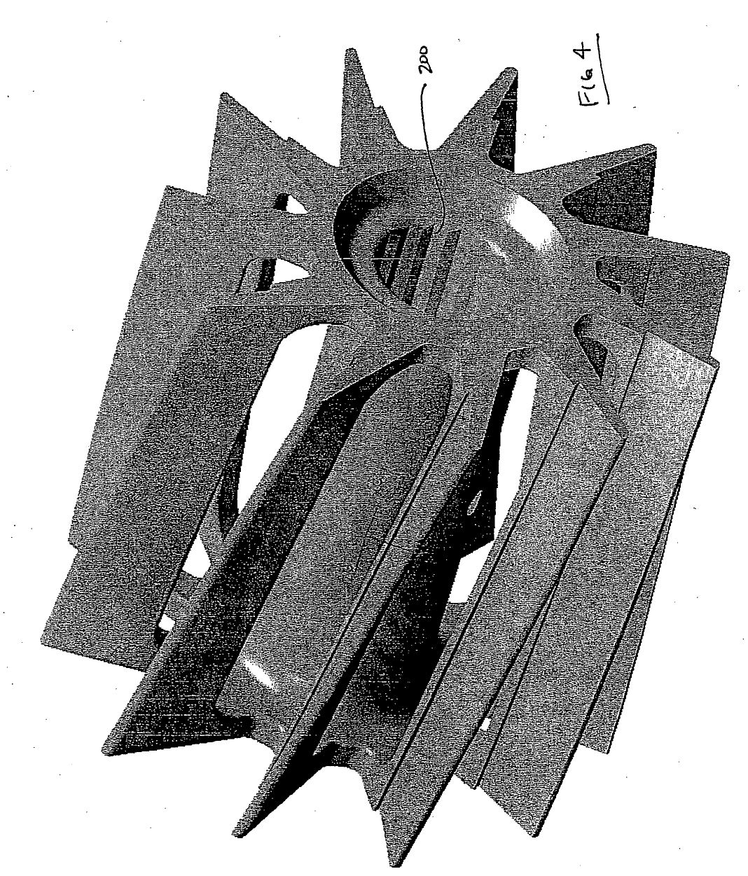

Reel 30 is preferably provided in relatively-short length sections, such as for instance about 4-5″. These shorter reel sections are disposed in an end-to-end arrangement to provide any one of a number of desirable final lengths, such as for instance 16″, 20″, 24″, 28″, and 32″. These short reel sections may be coupled together according to any one of a number of known methods. For example, as seen in FIG. 4, reel 30 may include a splined surface 200 disposed within reel shaft 104. Splined surface 200 is adapted to engage a support shaft (not shown) having a corresponding splined surface for rotation therewith. The support shaft may be operably coupled to sprockets 25 of transmission 22 to rotatably drive reel 30.

These relatively-short length sections provide improvements in manufacturing in that they simplify the casting process. As is known, large intricate castings may be difficult to cast due to fluid flow limitations. To this end, it is anticipated that such shorter reel shafts may be threadedly engaged with each other to provide both a bearing support and a power transmission capability. However, it should be understood that longer length sections may also be manufactured according to more recent casting processes.

According to the present invention, reel 30 includes blade supports 102 mounted onto or formed integrally with reel shaft 104. In the case that blade supports 102 are mounted on reel shaft 104, blade supports 102 may be locked into position relative to the reel shaft using locking fasteners or any other known method or device. The blade supports rotate together with the reel shaft and are maintained in this fixed relative position via the use of a keyway; a square, hex, or octagonal shaped reel shaft and correspondingly shape feature on the blade supports; or by using a retaining compound to fixedly couple the blade supports to the reel shaft.

As described above and with reference to FIGS. 2 and 3, reel 30 is shown having an integrally-formed (casted) reel shaft 104 and a plurality of blade supports 102. More particularly, reel shaft 104 is generally cylindrically-shaped and defines a central axis B-B. The plurality of blade supports 102 each have a pair of depending legs 106 integrally formed with reel shaft 104 at a proximal end 108 thereof. Legs 106 radiate outwardly from reel shaft 104. However, as best seen in FIG. 3, legs 106 are inclined such that an axis C-C of each leg 106 is not aligned with central axis B-B of reel shaft 104. A cross member 110 is further integrally formed with a distal end 112 of the pair of depending legs 106 to bridge the pair of legs 106. As seen in FIG. 2, legs 106 are further arranged such that cross members 110 form a helical arrangement relative to central axis B-B.

Still referring to FIGS. 2 and 3, cross member 110 defines a front face 114, a back face 116, and a blade groove 118. Front face 114 further includes a plurality of magnet pockets 120 formed therein. Each magnet pocket 120 is generally a recess appropriately sized to receive a magnet 122 therein. Magnets 122 are further appropriately sized to engage and retain a removable blade member 124 during operation. In other words, magnets 122 must have appropriate retaining capability to prevent the inadvertent disengagement of blade member 124 from cross member 110 during operation.

To further prevent the inadvertent disengagement of blade member 124 relative to cross member 110 or the possible misalignment of blade member 124 relative to bedknife 34, cross member 110 further includes at least one centripetal force pin 126. Centripetal force pin 126 is sized to be received within an aperture 128 formed in blade member 124. Centripetal force pin 126 and aperture 128 cooperate to prevent the inadvertent outward movement of blade member 124 relative to cross member 110 in response to centripetal force during high-speed rotation of reel 30.

Blade groove 118 of cross member 110 further serves to ensure the proper positioning of blade member 124 relative to cross member 110 and consequently bedknife 34. As best seen in FIG. 3, blade groove 118 is generally U-shaped and sized to receive a proximal end 130 of blade member 124 therein. U-shaped blade groove 118 generally surrounds a portion of blade member 124 to prevent blade member 124 from pivoting out of engagement with blade groove 118 in direction D (FIG. 3). In other words, blade groove 118 serves to counteract the force applied to distal end 132 (cutting end) of blade member 124 during cutting. A lip 134 of blade groove 118 engages distal end 132 of blade member 124 to maintain the proper positioning of blade member. Furthermore, the longitudinal arrangement of blade groove 118 serves to further prevent the inadvertent twisting of blade member 124 about centripetal force pin 126.

With particular reference to FIG. 3, it can be seen that front face 114 further serves to support blade member 124 from twisting or pivoting during operation in that front face 114 extends along a large portion of blade member 124. Thus, forces exerted upon blade member 124 are transferred directly to front face 114 of cross member 110 and finally to reel shaft 104.

During operation, blade member 124 will be in proper cutting relationship with bedknife 34 to achieve the desired level of cut. However, as can be appreciated, during use blade member 124 will eventually wear to a point requiring replacement. To facilitate this replacement, the present invention provides a simple method—specifically, a user may replace blade members 124 simply by pivoting blade members 124 about blade groove 118 against the magnetic force of magnets 122. Once blade members 124 are removed from cross member 110, replacement blade members may be quickly inserted into blade groove 118 and rotated into magnetic locking engagement with magnets 122 and alignment with centripetal force pin 126.

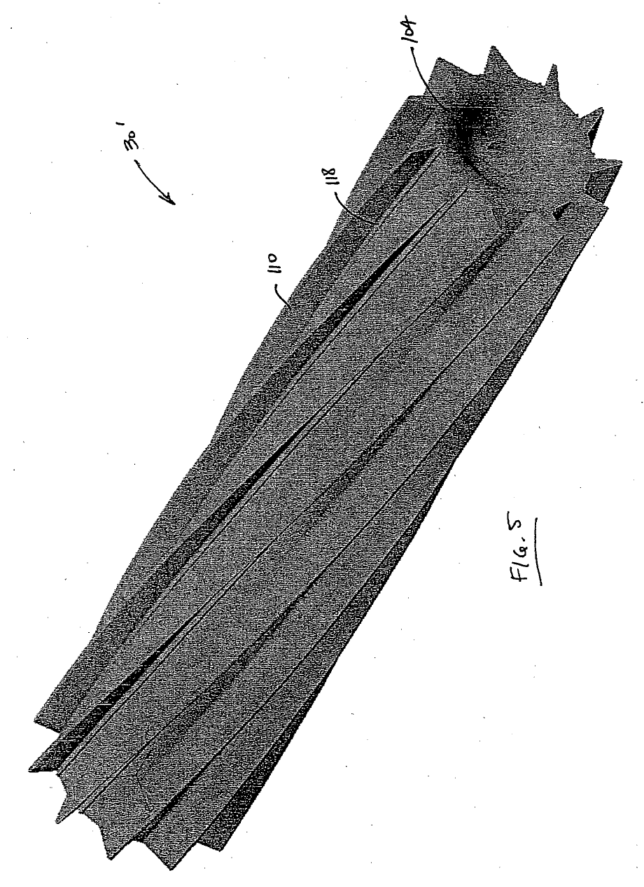

It should be understood that alternative embodiments may be used to achieve the principles of the present invention. With particular reference to FIG. 5, it should be understood that the reel, generally referenced as 30′, may have a solid-construction. That is, reel 30′ may include a generally solid reel shaft 104′ and a plurality of cross members 110 formed integrally therewith, without the need for legs 106. However, it is anticipated that such arrangement would still include a removable blade member 124 fixedly coupled to cross member 110.

Likewise, it is anticipated that alternative mounting methods may be used to coupled blade member 124 to cross member 110 in addition to the aforementioned magnetic attachment method. For example, it should be understood that blade member 124 may be removably coupled to cross member 110 using an interference fit arrangement between centripetal force pin 126 and blade groove 118. That is, the distance between centripetal force pin 126 and blade groove 118 may be smaller than a distance between proximal end 130 of blade member 124 and aperture 128. Therefore, during assembly, blade member 124 may be inserted into blade groove 118 and rotated into position such that a preload on blade member 124 is required to engage centripetal force 126 within aperture 128. This interference fit would then retain blade member 124 in engagement with cross member 110 without requiring magnets 122.

Additionally, an adhesive material may be used to coupled blade member 124 to front face 114 of cross member 110. Such adhesive material, such as LOCTITE, may be used to properly position and retain blade member 124 within blade groove 118. In this regard, both magnet 122 and centripetal force pin 126 may be eliminated. The adhesive material may be releasable upon application of heat.

Still further, blade member 124 may be coupled to cross member 110 using standard fasteners disposed between blade member 124 and cross member 110. To this end, both magnet 122 and centripetal force pin 126 may again be eliminated.

Finally, as seen in FIG. 6, blade member 124 may be coupled with cross member 110 using a tongue and groove arrangement. Specifically, blade member 124 may include a tongue 300 extending from proximal end 130 that is sized to be received within an ancillary groove portion 302 formed in blade groove 118. This could permit blade member 124 to be easily slid or rotated into position and retained reliably relative to cross member 110.

For these reasons, it is believed that the present invention provides a number of advantages over the prior art and further provides a simple and convenient method replacing worn reel cutting blades.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A reel mower assembly comprising:
a frame;
a reel rotatably mounted to the frame, the reel having a plurality of cross members connected with a reel shaft;
a drive operative to rotate the reel about a reel axis;
a blade member, and
an engagement system operably coupling the blade member to one of the plurality of cross members to prevent movement of the blade member with respect to the cross member.

2. The reel mower assembly according to claim 1 wherein the engagement system is a pin extending from one of the blade member and the cross member and an aperture formed in the other of the blade member and the cross member, the pin being sized to be received within the aperture to resist the sliding movement.

3. The reel mower assembly according to claim 2 wherein the cross member includes a blade groove formed therein for receiving a proximal end of the blade member.

4. The reel mower assembly according to claim 3 wherein a distance between the blade groove and the pin is smaller than a distance between the proximal end of the blade member and the aperture to form an interference fit between the blade member and the cross member.

5. The reel mower assembly according to claim 3 wherein the blade groove is generally U-shaped to capture the proximal end of the blade member.

6. The reel mower assembly according to claim 1 wherein the engagement system is a magnet providing a magnetic attractive force between the blade member and the cross member.

7. The reel mower assembly according to claim 6 wherein the engagement system permits the blade member to be removed from the cross member when a separating force is exerted on the blade member in a direction away from the cross member that is greater than the attractive force.

8. The reel mower assembly according to claim 6 wherein the magnet is disposed within a front face of the cross member.

9. The reel mower assembly according to claim 1 wherein the engagement system includes an adhesive material disposed between the cross member and the blade member.

10. The reel mower assembly according to claim 1 wherein the engagement system is a fastener disposed between the cross member and the blade member.

11. The reel mower assembly according to claim 1 wherein the engagement system is a tongue and groove system between the cross member and the blade member.

12. A reel for use in a reel mower assembly, the reel comprising:
a reel shaft;
a reel having a plurality of cross members connected with the reel shaft;
a blade member, and
an engagement system operably coupling the blade member to one of the plurality of cross members to prevent movement of the blade member with respect to the cross member.

13. The reel according to claim 1 wherein the engagement system is a pin extending from one of the blade member and the cross member and an aperture formed in the other of the blade member and the cross member, the pin being sized to be received within the aperture to resist the sliding movement.

14. The reel according to claim 13 wherein the cross member includes a blade groove formed therein for receiving a proximal end of the blade member.

15. The reel according to claim 14 wherein a distance between the blade groove and the pin is smaller than a distance between the proximal end of the blade member and the aperture to form an interference fit between the blade member and the cross member.

16. The reel according to claim 14 wherein the blade groove is generally U-shaped to capture the proximal end of the blade member.

17. The reel according to claim 1 wherein the engagement system is a magnet providing a magnetic attractive force between the blade member and the cross member.

18. The reel according to claim 17 wherein the engagement system permits the blade member to be removed from the cross member when a separating force is exerted on the blade member in a direction away from the cross member that is greater than the attractive force.

19. The reel according to claim 17 wherein the magnet is disposed within a front face of the cross member.

20. The reel according to claim 12 wherein the engagement system includes an adhesive material disposed between the cross member and the blade member.

21. The reel according to claim 12 wherein the engagement system is a fastener disposed between the cross member and the blade member.

22. The reel according to claim 12 wherein the engagement system is a tongue and groove system between the cross member and the blade member.
